(19) United States
(12) Patent Application Publication
(10) Pub. No.: US 2021/0282523 A1
(43) Pub. Date: Sep. 16, 2021

(54) HAIR DRYER AND METHOD FOR CALIBRATING TEMPERATURE THEREOF

(71) Applicants: SHENZHEN AIRGLE CORPORATION LIMITED, Shenzhen (CN); AIRGLE CORPORATION, Holbrook, NY (US)

(72) Inventors: Xin LIU, SHENZHEN (CN); Zheng LIU, SHENZHEN (CN); Yong XU, SHENZHEN (CN); Guanjun LONG, SHENZHEN (CN); Lieqing NIE, SHENZHEN (CN); Shaoqi SHI, SHENZHEN (CN)

(21) Appl. No.: 16/836,966

(22) Filed: Apr. 1, 2020

(30) Foreign Application Priority Data
Mar. 12, 2020 (CN) 202010174691.2
Mar. 12, 2020 (CN) 202020310500.6

(51) Int. Cl. A45D 20/12

(52) U.S. Cl. CPC A45D 20/12; A45D 2200/15

(57) ABSTRACT

Disclosed are a hair dryer and a method for calibrating a temperature of the hair dryer. The hair dryer is applied for hair care, including: a housing; a heater disposed in the housing, in which the heater defines a flow channel configured for flowing air, and the heater is configured to heat the air flowing through the flow channel; a temperature measuring component disposed in the flow channel, in which the temperature measuring component is configured to measure a temperature of air flowing through the flow channel; and an auxiliary temperature measuring component disposed in the flow channel and the auxiliary temperature measuring component is configured to calibrate the temperature measured by the temperature measuring component.

### CROSS REFERENCE TO RELATED APPLICATION

The present application claims the priorities of Chinese Application No. 202020310500.6 filed Mar. 12, 2020, and the Chinese Application No. 202010174691.2 filed Mar. 12, 2020, the entire contents of which are hereby incorporated by reference.

### TECHNICAL FIELD

The present disclosure relates to the technical field of household appliances, in particular to a hair dryer and a method for calibrating a temperature of the hair dryer.

### BACKGROUND

Heating is usually necessary when a hair dryer is used for hair care, hair drying or hair styling. However, the temperature of the hair dryer is often too high, posing burning danger to the user and shortening the service life of the hair dryer. Therefore, a temperature detector is built in the hair dryer to detect the temperature of the hair dryer, avoiding its excessive temperature. However, the temperature value detected by the related temperature detector is not accurate enough to reflect the real temperature of the hair dryer.

The above content is only used to assist in understanding the technical solution of this application, and does not mean to admit that the above content is prior art.

### SUMMARY

Given to the above, a hair dryer as well as a method for calibrating the temperature of the hair dryer is proposed, to resolve the problem that the temperature detector fails to accurately reflect the real temperature of the hair dryer, and effectively ensure the accuracy of temperature detection.

In order to achieve the above object, the hair dryer is provided by the present disclosure, which includes:

a housing;

a heater disposed in the housing, in which the heater defines a flow channel configured for flowing air, and the heater is configured to heat the air flowing through the flow channel;

a temperature measuring component disposed in the flow channel, wherein the temperature measuring component is configured to measure a temperature of air flowing through the flow channel; and

an auxiliary temperature measuring component disposed in the flow channel and the auxiliary temperature measuring component is configured to calibrate the temperature measured by the temperature measuring component.

In some embodiment, the heater includes an outer tube and an inner tube disposed inside the outer tube, forming an annular flow channel between the outer tube and the inner tube.

In some embodiment, the temperature measuring component and the auxiliary temperature measuring component are disposed at an outlet end of the flow channel.

In some embodiment, the temperature measuring component is located at a first position in the annular flow channel, and the auxiliary temperature measuring component is located at a second position in the annular flow channel, in which an arc formed by the first position and the second position is 180 degrees.

In some embodiment, the hair dryer comprises heating fins spaced in the flow channel.

In some embodiment, the spaced heating fins define interval spaces; the hair dryer comprises more than one auxiliary temperature measuring components, in which each of the auxiliary temperature measuring components is disposed in each of the interval spaces.

In some embodiment, the temperature measuring component and the auxiliary temperature measuring component includes thermistors.

In some embodiment, an air inlet and an air outlet are defined at an surface of the housing; the housing further includes a main body part and a hand-held part, forming an included angle therebetween, and in which the air outlet is disposed at the main body part, the heater is disposed in the main body part close to the air outlet, and the air inlet is disposed in the main body part away from from the air outlet.

In some embodiment, an air inlet and an air outlet are defined at an surface of the housing; the housing further includes a main body part and a hand-held part, forming an included angle therebetween, and in which the air outlet is disposed at the main body part, the heater is disposed in the main body part close to the air outlet, and the air inlet is disposed in the hand-held part away from from the air outlet.

In addition, in order to achieve the above object, the present disclosure also provides a method for calibrating a temperature of a hair dryer, which is applied to the hair dryer described above, and the method includes:

controlling the heater to heat the air flowing through the flow channel;

controlling the temperature measuring component to measure an air temperature and obtain a first measuring value;

controlling the auxiliary temperature measuring component to measure the air temperature and obtain second first measuring value;

differencing on the first measuring value and the second measuring value and obtain a difference value;

determining the difference value to be within a preset threshold range;

in response to a determination that the difference value is out of the preset threshold range, taking the second measuring value as a temperature result, or taking an average value of the first measuring value and the second measuring value as the temperature result;

in response to a determination that the difference value is within the preset threshold range, taking the first measuring value as the temperature result.

In the technical solution provided by the present disclosure, a heater is arranged in the housing of the hair dryer, the heater forms a flowing channel and further heats the air flowing through the flow channel. A temperature measuring component and an auxiliary temperature measuring component are respectively arranged in the flow channel. The temperature measuring component and the auxiliary temperature measuring component can measure the air in the flow channel, and the result measured by the temperature measuring component can be calibrated and corrected by the auxiliary temperature measuring component. The measurement accuracy is thereby ensured.

### BRIEF DESCRIPTION OF THE DRAWINGS

In order to explain the embodiment of the present disclosure or the technical solution of the prior art more clearly, the following will briefly introduce the drawings necessary in the description of the embodiments or the prior art. Obviously, the drawings in the following description are only some embodiments of the present disclosure. For those of ordinary skill in the art, other drawings can be obtained according to the structure shown in these drawings without any creative effort.

FIG. 1 is a schematic structural diagram of a heater of a hair dryer according to an embodiment of the present disclosure;

FIG. 2 is a schematic structural diagram of a housing of a hair dryer according to an embodiment of the present disclosure;

FIG. 3 is a schematic structural diagram of a housing in a hair dryer according to another embodiment the present disclosure;

FIG. 4 is a flow chart of a method for calibrating a temperature of a hair dryer according to an embodiment of the present disclosure.

### DESCRIPTION OF REFERENCE NUMERALS

| Reference | |
|---|---|
| Numeral | Name |
| 10 | Housing |
| 110 | Main body part |
| 120 | Hand-held part |
| 130 | Air inlet |
| 140 | Air outlet |
| 20 | Heater |
| 210 | Flow channel |
| 220 | Outer tube |
| 230 | Inner tube |
| 30 | Temperature measuring |
| | component |
| 40 | Auxiliary temperature |
| | measuring component |
| 50 | Heating fin |

The implementation, functional features and advantages of the present application will be further described with reference to the accompanying drawings with the embodiments.

### DETAILED DESCRIPTION OF THE EMBODIMENTS

As following, the technical solution in the embodiments of the present disclosure will be described clearly and completely with reference to the drawings in the embodiment of the present disclosure. Obviously, the described embodiment is only a part of the embodiment of the present disclosure, not all of the embodiments. Based on the embodiments in the present disclosure, all other embodiments perceived by those ordinary skills in the art without creative effort should be fallen within the protection scope of the present disclosure.

It should be noted that all directional indicators (such as upper, lower, left, right, front, rear, etc.) in the embodiment of the present disclosure are only used to explain the relative positional relationship, movement, etc. between various components under a certain specific posture (as shown in the drawings). If the specific posture changes, the directional indicator will also change accordingly.

In addition, the descriptions related to “first”, “second” and the like in the present disclosure are for descriptive purposes only and cannot be understood as indicating or implying its relative importance or implicitly indicating a number of technical features indicated. Thus, features defining “first” and “second” may explicitly or implicitly include at least one of the features. In the description of the present application, the meaning of “plural” is at least two, such as two, three, etc., otherwise specifically defined.

In the present disclosure, the terms “connected” and “fixed” etc. should be understood in a broad sense, otherwise specified and defined. For example, “fixed” can be a fixed connection, a detachable connection, or an forming a part integrally; it can be a mechanical connection or an electrical connection; it can be a direct connection or an indirect connection through an intermediate medium; and it can be the communication between interior of two elements or the interaction between two elements, otherwise specifically defined. For those ordinary skilled in the art, the specific meanings of the aforementioned terms in the present disclosure can be understood according to practical conditions.

In addition, the technical solutions between the various embodiments can be combined with each other, but it must be based on the realization by ordinary skilled in the art. When the combination of technical solutions is contradictory or cannot be realized, it should be considered that the combination of such technical solutions does not exist and is not within the scope of protection claimed in the present disclosure.

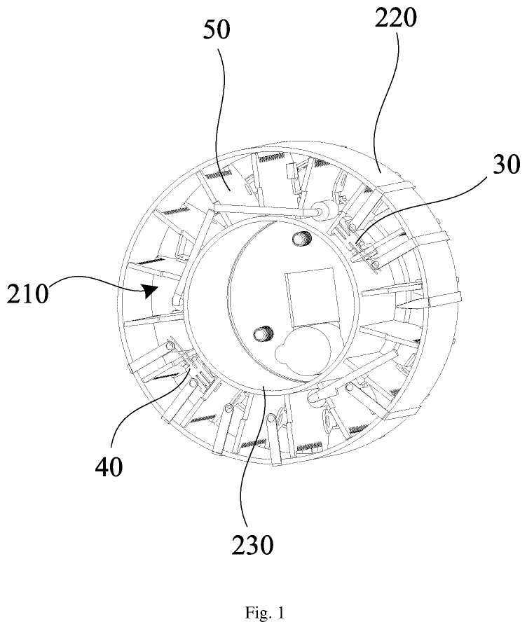

Referring to FIG. 1, in some embodiment, a hair dryer is applied to hair care. The hair dryer includes a housing 10, a heater 20, a temperature measuring component 30 and an auxiliary temperature measuring component 40. The heater 20, the temperature measuring component 30 and the auxiliary temperature measuring component 40 are all arranged in the housing 10. The housing can be made of metal or plastic. The metal housing can better support the internal space, while the plastic material is easy to process. For example, the housing can be integrally molded by injection molding. The plastic housing can also have a better insulation. In addition, the housing 10 may also be manufactured by 3D printing, which uses adhesive materials such as powdered metal or plastic to construct objects through layer-by-layer printing.

The heater 20 is arranged in the housing 10, and is provided with a flow channel 210 through which air flows. The heater 20 is used to heat the air passing through the flow channel 210. Specifically, the heater 20 is to convert electricity into heat, including heating wires or heating fins which have high electric heating conversion efficiency. When the air flows through the flow channel 210 of the heater 20, energy of the air has been transferred passing through the surface of the heater 20, the energy has been transferred to the air from the surface of the heater, and the temperature of the air increases. The hair dryer blows out the heated air, which accelerate the evaporation rate of hair moisture.

The temperature measuring component 30 is arranged in the flow channel 210, and is used for measuring the temperature of the air flowing through the flow channel 210. The auxiliary temperature measuring component 40 is arranged in the flow channel 210, and is used for calibrating the temperature measured by the temperature measuring component 30. It could be appreciated that, both the temperature measuring component 30 and the auxiliary temperature measuring component 40 can measure the temperature of the gas. The measured result is primarily dependent on the temperature measuring component 30 and the measured result by the auxiliary temperature measuring component 40 is secondary. In other words, the results measured by the temperature measuring component 30 are usually accurate. In case an obvious error is detected, the results measured by the auxiliary temperature measuring component 40 can prevail. For example, in case that the temperature measuring component 30 fails to measure, or the measured results fluctuate greatly, which indicates that the temperature measuring component cannot work normally. In this manner, an accurate temperature of the air is relied upon the measurement by the auxiliary temperature measuring component 40. Alternatively, in case that the difference is significant of the measured results by the temperature measuring component 30 and the auxiliary temperature measuring component 40, an average value can be taken as the measured temperature of the gas.

In the technical solution provided by the present embodiment, a heater 20 is arranged in the housing 10 of the hair dryer, the heater 20 forms a flowing channel 210 and further heats the air flowing through the flow channel 210. A temperature measuring component 30 and an auxiliary temperature measuring component 40 are respectively arranged in the flow channel 210. The temperature measuring component 30 and the auxiliary temperature measuring component 40 can measure the air in the flow channel 210, and the result measured by the temperature measuring component 30 can be calibrated and corrected by the auxiliary temperature measuring component 40. The measurement accuracy is thereby ensured.

In some embodiment, the heater 20 includes an outer tube 220 and an inner tube 230 disposed inside the outer tube 220. An annular flow channel 210 is formed between the outer tube 220 and the inner tube 230. Through the annular flow channel 210, the air flow out of the hair dryer in an annular shape, so as to prevent the air from being too concentrated and to diverge the blowing angle as much as possible. A larger blowing area is thereby obtained when the hair dryer is used. In addition, the surfaces of the outer tube 220 and the inner tube 230 can also be used for heating the gas. When the air is heated in the annular flow channel 210, the heating area of the air can be increased having double heating surface of the inner layer and the outer layer. The heating efficiency has been improved.

In some embodiment, the temperature measuring component 30 and the auxiliary temperature measuring component 40 are provided at the outlet end (not shown) of the flow channel 210. Generally, as the heated air flowing out of the hair dryer is used to dry the wet hair of the user, the acquisition of the air temperature acting on the hair should be as accurately as possible. If the air temperature is over too high, it may cause damage to human hair or even human skin; and if the air temperature is too low otherwise, it may not be effective enough to dry the wet hair. The outlet end of the hair dryer is typically close to the hair. The temperature measuring component 30 and the auxiliary temperature measuring component 40 are thus arranged at the outlet end of the flow channel 210, to acquire the temperature more accurately when the air flows out from the hair dryer. In addition, the heating power of the hair dryer can be adjusted according to the measured air temperature. For example, when the measured temperature is high, the heating power can be reduced or heating can be suspended. And when the measured temperature is lower, the heating power can be increased. Furthermore, a controller (not shown) is arranged in the hair dryer. The temperature measuring component 30 and the auxiliary temperature measuring component 40 are electrically connected with the controller, respectively. The temperature measuring component 30 and the auxiliary temperature measuring component 40 may transmit the measured signals to the controller. The controller turns the heating power and therefore the heater on and off based on the received signals.

In some embodiment, the arc angle in the annular flow channel 210 formed between the temperature measuring component 30 and the auxiliary temperature measuring component 40 is 180 degrees. More specifically, the temperature measuring component 30 and the auxiliary temperature measuring component 40 are respectively positioned at the radial direction center of the annular flow channel 210. It can also be appreciated that the temperature measuring component 30 and the auxiliary temperature measuring component 40 are arranged at positions distal from each other, so that the temperature measuring component 30 and the auxiliary temperature measuring component 40 can measure respective air temperatures at different positions. The situation that measurement is inaccurate due to over-high local temperature is avoided. In other words, local temperature measurement is avoided of the heater 20. The heater 20 interior may be heated unevenly, resulting in too high or too low a temperature in some positions. By setting the temperature measuring component 30 and the auxiliary temperature measuring component 40 being distal from each other, a larger range of air temperature can be detected, and a true temperature of the air can be obtained. In addition, by such configuration that the two measuring components being arranged on an arc of 180 degrees, it is also possible to detect an abnormal condition that the local temperature of the heater 20 is too high or too low. For example, if the temperature difference measured by the temperature measuring component 30 and the auxiliary temperature measuring component 40 is too large, an indication would be given, and further inspection and maintenance should be carried out on the hair dryer.

In some embodiment, the hair dryer includes a plurality of heating fins 50 which are arranged at certain intervals in the flow channel 210. In other words, heating unit is added to enable the air to obtain heat faster. In addition, it can be known that the heating fin 50 is in the form of a sheet, whereby a larger heating area can be formed to rapidly heat up the gas. Among them, the material of the heating fin 50 includes electrothermal alloy such as iron chromium aluminum or nickel chromium. These existing materials are electrothermal conversion efficient and oxidation resistant. The spacing between the heating fins 50 in the flow channel 210 can increase the air heating speeds in the flow channel 210. Further, the space between each two adjacent heating fins 50 is equal. That is, the heating fins 50 are uniformly configured in the flow channel 210, ensuring the uniformity of the heating as well as the overall heat balance of the gas. Local temperature deviation from the averaged temperature measured is avoided.

In some embodiment, the heating fins 50 are spaced to form an interval space, and the hair dryer includes a plurality of auxiliary temperature measuring components 40, and each interval space is provided with an auxiliary temperature measuring component 40. Furthermore, the distance between each two adjacent heating plates 50 is equal, forming multiple equal interval spacing. As the air passes through the equally-sized interval spaces, the equilibrium of the heating temperature of the air can be effectively ensured.

In addition, in another embodiment, the hair dryer includes a plurality of temperature measuring components 30, and each spacing is provided with a temperature measuring component 30. And the temperature measuring component 30 is uniformly arranged in the interval spacing, so that the temperature of the air can be measured more comprehensively and accurately. It should also be appreciated that the number of the temperature measuring component 30 and the auxiliary temperature measuring component 40 can be specified and set according to the number of space intervals. Measurements of the multiple local temperatures ensure the accuracy of temperature measurement.

In some embodiment, the temperature measuring component 30 and the auxiliary temperature measuring component 40 include thermistors. It can be appreciated that the temperature measuring principle can be the identical regarding the temperature measuring component 30 and the auxiliary temperature measuring component 40. Thermistors are sensitive elements, which are divided into positive temperature coefficient thermistor and negative temperature coefficient thermistor, according to its temperature coefficient. The thermistors are sensitive to temperature and shows different resistance at different temperatures. As being a semiconductor element, the higher the temperature is, the greater the resistance value is. In addition, the temperature measuring component 30 and the auxiliary temperature measuring component 40 may also include other temperature measuring elements, such as thermocouples or thermal resistances. Alternatively, the temperature measuring principles of the temperature measuring component 30 and the auxiliary temperature measuring component 40 may be different. For example, both of them may include one of thermal sensitivity, thermocouple or thermal resistance.

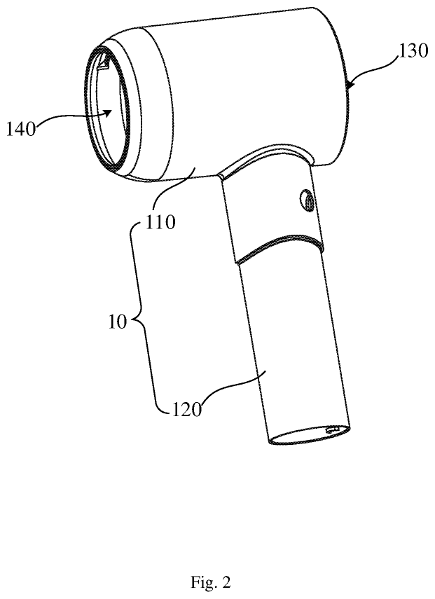

Referring to FIG. 2, in some embodiment, the surface of the housing 10 is provided with an air inlet 130 and an air outlet 140. The housing 10 further includes a main body part 110 and a hand-held part 120. An included angle is formed between the main body part 110 and the hand-held part 120. The air outlet 140 is disposed in the main body part 110, and the heater 20 is disposed in the main body part 110 proximal to the air outlet 140; while the air inlet 130 is disposed in the main body part 110 distal from the air outlet 140. As such, it can be appreciated that the main body part forms a cavity penetrating back and forth therein, and the air flows in the cavity of the main body part 110. The air enters into the main body part 110 through the air inlet 130, is then heated by the heater 20, and flows out through the air outlet 140. With such arrangement, the air flow path is relatively short, facilitating the rapid flow of the gas. The angle between the main body part 110 and the hand-held part 120 refers to the angle between the direction of the air outlet 140 in the main body part 110 and the direction of the hand-held part 120 facing the air outlet 140. The angle has three scenarios, including acute angle, right angle and obtuse angle.

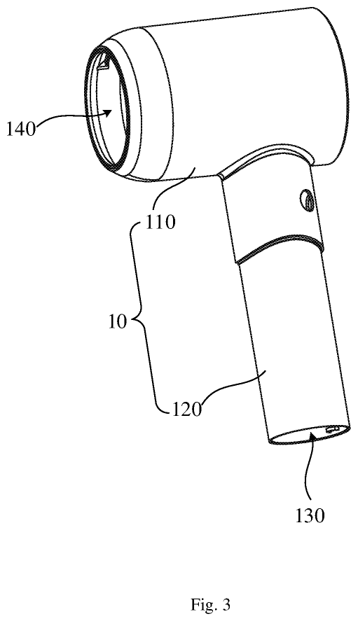

Referring to FIG. 3, in some embodiment, the air inlet 130 may have another configuration. More specifically, the surface of the housing 10 is provided with an air inlet 130 and an air outlet 140. The housing 10 further includes a main body part 110 and a hand-held part 120. An included angle is formed between the main body part 110 and the hand-held part 120. The air outlet 140 is disposed in the main body part 110, and the heater 20 is disposed in the main body part 110 proximal to the air outlet 140; while the air inlet 130 is disposed in the hand-held part 120 distal from the air outlet 140. As such, it can be appreciated that the interior of the hand-held part 120 has a cavity communicated with the main body part 110. The air enters into the hand-held part 120 through the air inlet 130 of the hand-held part 120, then enters into the main body part 110, before heated by the heater 20, and then flows out through the air outlet 140 of the main body part 110. Thus, when the hair dryer is used, the air enters from the lower part of the hair dryer, and the air inlet 130 is more concealed.

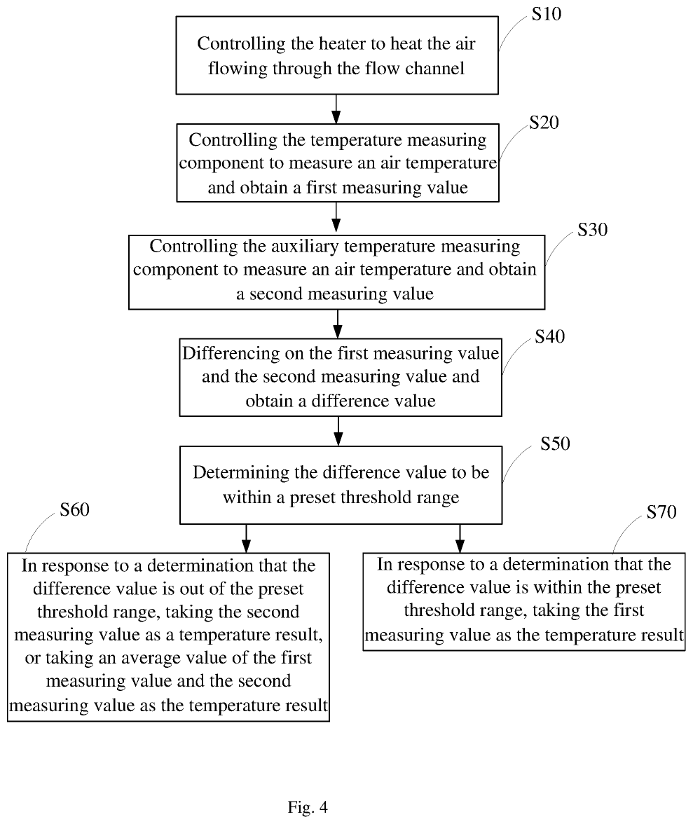

Referring to FIG. 4, the present disclosure also provides a method for calibrating a temperature of the hair dryer described above. The method includes:

Operation S10, controlling the heater to heat the air flowing through the flow channel. More specifically, a controller is arranged inside the hair dryer. The heater is electrically connected to the controller, and the heater is controlled to be turned on and off through the controller. The controller can also control the power of the heater. The hair dryer is provided with a motor fan and a switch. When the hair dryer is used, the fan is controlled to rotate by turning the switch, and the heater is turned on to heat the air flowing through the flow channel.

Operation S20, controlling the temperature measuring component to measure an air temperature and obtain a first measuring value. More specifically, the temperature measuring component is connected with the controller. The temperature measuring component measures the temperature of the air to obtain a first measuring value, and transmits the first measuring value to the controller. The controller further includes a storing unit, in which the first measuring value is stored.

Operation S30, controlling the auxiliary temperature measuring component to measure an air temperature and obtain a second measuring value. More specifically, the temperature measuring component is connected with the controller. The temperature measuring component measures the temperature of the air to obtain a first measuring value, and transmits the first measuring value to the controller. The first measuring value is stored in the storing unit.

Operation S40, differencing on the first measuring value and the second measuring value and obtain a difference value; More specifically, a first measuring value and a second measuring value are extracted from a storage unit. A difference is calculated base on the first measuring value and the second measuring value, namely a difference value.

In step S50, determining the difference value to be within a preset threshold range. A threshold range is preset in the controller. It is judged that whether the difference value to be within the range.

Operation S60, in response to a determination that the difference value is out of the preset threshold range, taking the second measuring value as a temperature result, or taking an average value of the first measuring value and the second measuring value as the temperature result. It should be appreciated that the result can be achieved in two manners. In the first manner, the second measuring value is taken as the temperature result, which is typically the case when the temperature measuring component 30 cannot function normally. In the second manner, the average value of the first measuring value and the second measuring value is taken as the temperature result, which can average the measurement value and minimize the influence of the local measurement point on the temperature measurement.

Operation S70, in response to a determination that the difference value is within the preset threshold range, taking the first measuring value as the temperature result. As such, the difference value does not exceed the range, indicating that the temperature measuring component can work normally. In this manner, the first measuring value measured by the temperature measuring component is the measurement result. Alternatively, even though the difference value is within the preset range, the average value calculated from the first measuring value and the second measuring value can also be taken as the temperature result. According to the present method, after comparing the first measuring value measured by the temperature measuring component to the second measuring value measured by the auxiliary temperature measuring component, it is determined that whether the temperature measuring component works normally according to difference between the two. And when the temperature measuring component works abnormally or the temperature measurement is not accurate enough, the measured result is calibrated by the auxiliary temperature measuring component, effectively ensuring the accuracy of the measured result.

The above is only the optional embodiment of the present disclosure and does not therefore constitute a limitation to the present disclosure. Any equivalent structure modification perceived by using the contents of the present specification and drawings, or directly or indirectly applied in other related technical fields, shall be included in the protection scope of the present disclosure.

What is claimed is:

1. A hair dryer, comprising:
a housing;
a heater disposed in the housing, wherein the heater defines a flow channel configured for flowing air, and the heater is configured to heat the air flowing through the flow channel;
a temperature measuring component disposed in the flow channel, wherein the temperature measuring component is configured to measure a temperature of air flowing through the flow channel; and
an auxiliary temperature measuring component disposed in the flow channel, wherein the auxiliary temperature measuring component is configured to calibrate the temperature measured by the temperature measuring component.

2. The hair dryer of claim 1, wherein the heater comprises an outer tube and an inner tube disposed inside the outer tube, allowing the flow channel to be annular between the outer tube and the inner tube.

3. The hair dryer of claim 2, wherein the temperature measuring component and the auxiliary temperature measuring component are disposed at an outlet end of the flow channel.

4. The hair dryer of claim 3, wherein:
the temperature measuring component is located at a first position in the annular flow channel; and
the auxiliary temperature measuring component is located at a second position in the annular flow channel, wherein an arc formed by the first position and the second position is 180 degrees.

5. The hair dryer of claim 1, wherein the hair dryer comprises heating fins spaced in the flow channel.

6. The hair dryer of claim 5, wherein
the spaced heating fins define interval spaces;
the hair dryer comprises more than one auxiliary temperature measuring components, wherein
each of the auxiliary temperature measuring components is disposed in each of the interval spaces.

7. The hair dryer of claim 1, wherein
the temperature measuring component and the auxiliary temperature measuring component comprise thermistors.

8. The hair dryer of claim 1, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

9. The hair dryer of claim 2, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

10. The hair dryer of claim 3, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

11. The hair dryer of claim 4, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

12. The hair dryer of claim 5, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

13. The hair dryer of claim 6, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the main body part away from from the air outlet.

14. The hair dryer of claim 1, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

15. The hair dryer of claim 2, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

16. The hair dryer of claim 3, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

17. The hair dryer of claim 4, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

18. The hair dryer of claim 5, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

19. The hair dryer of claim 6, wherein
an air inlet and an air outlet are defined at an surface of the housing;
the housing further comprises a main body part and a hand-held part, forming an included angle therebetween, and wherein
the air outlet is disposed at the main body part,
the heater is disposed in the main body part close to the air outlet, and
the air inlet is disposed in the hand-held part away from from the air outlet.

20. A method for calibrating a temperature of a hair dryer,
the hair dryer comprising:
a housing;
a heater disposed in the housing, wherein the heater defines a flow channel configured for flowing air, and the heater is configured to heat the air flowing through the flow channel;
a temperature measuring component disposed in the flow channel, wherein the temperature measuring component is configured to measure a temperature of air flowing through the flow channel; and
an auxiliary temperature measuring component disposed in the flow channel, wherein the auxiliary temperature measuring component is configured to calibrate the temperature measured by the temperature measuring component;
wherein the method comprises:
controlling the heater to heat the air flowing through the flow channel;
controlling the temperature measuring component to measure an air temperature and obtain a first measuring value;
controlling the auxiliary temperature measuring component to measure the air temperature and obtain second first measuring value;
differencing on the first measuring value and the second measuring value and obtain a difference value;
determining whether the difference value to be within a preset threshold range;
in response to a determination that the difference value is out of the preset threshold range, taking the second measuring value as a temperature result, or taking an average value of the first measuring value and the second measuring value as the temperature result;
in response to a determination that the difference value is within the preset threshold range, taking the first measuring value as the temperature result.
